(19) United States
(12) Patent Application Publication
(10) Pub. No.: US 2017/0074682 A1
(43) Pub. Date: Mar. 16, 2017

(54) POSITION MEASURING APPARATUS AND METHOD FOR OPERATING THE POSITION MEASURING APPARATUS

(71) Applicant: BALLUFF GmbH, Neuhausen a.d.F. (DE)

(72) Inventors: Zoltán KÁNTOR, Nemesvámos (HU); Zoltán PÓLIK, Gyoer (HU); Michael FRIEDRICH, Wolfschlugen (DE)

(73) Assignee: BALLUFF GmbH, Neuhausen a.d.F. (DE)

(21) Appl. No.: 15/119,407

(22) PCT Filed: Feb. 18, 2014
(86) PCT No.: PCT/DE2014/000064

§ 371 Date: Aug. 17, 2016

(51) Int. Cl. G01D 5/20

(52) U.S. Cl. CPC G01D 5/2053

(57) ABSTRACT

A position measuring apparatus measures the position(s) of an electrically conductive measurement object which can be moved over a measurement section, along which coils are positioned. A measuring coil is provided between every two excitation coils, through each of which excitation coils an alternating excitation current flows, which current is predefined to be in phase opposition from excitation coil to excitation coil. The alternating magnetic fields produced by the alternating excitation currents induce eddy currents in the electrically conductive measurement object when the measurement object moves past the excitation coils. The measuring coils provide an AC measurement voltage which is induced by the eddy currents flowing in the measurement object when the measurement object moves past the at least one measuring coil. The position of the measurement object is determined on the basis of the at least one AC measurement voltage.

The invention is based on a position measuring apparatus according to the preamble of the independent device claims respectively and on a method for operating the position measuring apparatus.

The applicant offers, for example, via the link leading to the applicant: http://www.Balluff.com, measuring apparatus for displacement and position measurement which are based on different physical principles, such as, for example, inductive distance sensors, micropulse displacement transducers, magneto-inductive displacement sensors, magnetically coded displacement and angle measuring systems and, for example, optoelectronic distance sensors. The measuring apparatus ultimately determine the position of a moving object with regard to a position sensor or the distance of a moving object from the position sensor.

In publication DE 10 2004 016 622 A1, a differential position measuring apparatus having a weak magnetic, elongated core is described, on which are arranged a primary coil which is able to be loaded by an alternating voltage as well as two negative feedback secondary coils connected in series and at a distance from one another. The measurement object has a permanent magnet saturating the core at the respective position and moves in a relative movement along the core. An evaluation unit is provided to detect the differential voltages induced in the secondary coils. The elongated core consists of two parallel, elongated core longitudinal regions, of which one bears the coils, wherein the elongated core longitudinal regions are connected to each other at the ends through transverse regions, forming a closed core. Due to the closed core, sidelobes outside the active sensor region can be reduced.

In patent specification U.S. Pat. No. 4,437,019 A, a position measuring apparatus is described which is implemented as a differential transformer. The position of a magnetisable measurement object is measured, said object being arranged to be displaceable in a tube. The tube is surrounded by two coil arrangements. A first coil arrangement contains a plurality of coil pairs, wherein the individual coils of the coil pairs are magnetised by means of an alternating current in respectively opposed directions. The coil pairs are arranged to be nested one inside the other. The second coil arrangement corresponds to a receiving coil which is wound over the entire length of the tube and provides an output signal. The information concerning the position of the magnetisable object which is arranged to be displaceable is contained in the phase position of the output signal, wherein, depending on the number of coil pairs, the phase position passes through the region from 0° to 360° multiple times depending on the position.

In patent specification U.S. Pat. No. 7,317,371 B1, a position measuring apparatus is described which is likewise implemented as a differential transformer. A tube wound by several coils is present, in which a magnetisable measuring object is arranged to be displaceable, the position of which is to be measured. At least one primary coil as well as both a first and a second secondary coil are provided. The two secondary coils are wound in such a way that a stepped structure results in the longitudinal direction of the tube. Each step is formed by a winding layer. The specific design of the windings causes the position value of zero to coincide with the centre point of the tube.

In publication DE 103 35 133 A1, a position measuring apparatus is described which detects the position of a metallic measurement object by use of a coil arrangement which has a plurality of coils arranged one next to the other. The coils are positioned along a measurement section in such a way that the sensitivity curves of coils which are directly adjacent to one another at least partially overlap. All coils are part of an oscillator. The presence of the metallic measurement object leads to a damping of the oscillator signal, such that the position of the measurement object can be concluded from the various damping of the signal in the individual coils.

In publication DE 10 2008 064 544 A1, an inductive position measuring apparatus is described which has a row of coils arranged one next to the other, which are arranged along a measurement section, along which a magnetic, in particular permanent magnetic measurement object is arranged to be displaceable, the position of which is to be detected. A second row of coils is provided which is positioned to be offset compared to the first coil row to increase the spatial resolution of the position sensor. The individual coils are part of an oscillator respectively. The metallic measurement object influences the quality of the resulting oscillating circuit and thus changes the amplitude of the oscillator signal, from which the position of the measurement object can be concluded.

In publication DE 101 30 572 A1, an inductive position measuring apparatus is also described which contains a plurality of coils arranged one next to the other, which can be switched between by means of a switch. The switch is connected to a capacitor such that a resonant circuit results which is stimulated by an oscillator. Depending on the position of a metallic measurement object, the quality of at least one oscillating circuit is reduced such that the resonant circuit voltage decreases. The position of the measurement object can be concluded from the decrease of the resonant circuit voltage.

In the utility model specification DE 201 20 658 U1, an inductive position measuring apparatus is described which has at least one primary coil and one secondary coil arrangement having several controlled eddy current surfaces. The controlled eddy current surfaces are positioned one next to the other opposite the primary coil respectively. The eddy current surfaces are short-circuited individually in chronological order respectively, such that an eddy current can be formed respectively. An evaluation unit detects a change in inductance of the primary coil depending on the switching status of the secondary coil arrangement, wherein the position of the measurement object can be determined from the output signal of the primary coil.

In the utility model specification DE 20 2007 012 087 U1, an inductive position measuring apparatus is described which has a plurality of inductive sensors which are positioned along a measurement section. The inductances of each individual inductive sensor are part of an oscillator, the frequency of which or at least the damping of which is influenced depending on the position of a measurement object. To detect different monitoring structures, the inductive sensors can be operated with position-dependent detection characteristics which are able to be adjusted differently.

Finally, in publication DE 10 2010 008 495 A1, a procedure for position measurement of an object is described in which a magnet allocated to the object is moved along a magnetostrictive waveguide, wherein the magnet produces a first magnetic excitation component in a region in the waveguide, for which furthermore a current signal having a current pulse is provided, which produces a current magnetic excitation in the waveguide, which has at least one excitation component in the waveguide which deviates from the excitation component produced by the magnet, such that a wave results in the determined region of the magnetostrictive waveguide due to the excitation change during the current pulse as a consequence of the magnetostrictive effect. The wave is detected in an evaluation unit, wherein the position of the object is determined from the traveltime of the wave in the waveguide. The known procedure uses a current signal which begins with a targetedly predetermined current increase ramp, the temporal progression of which is firstly determined in such a way that no wave is detected, but that such a current pulse is provided in connection to the current increase ramp which leads to the resulting of a detectable wave.

The object of the invention is to specify a position measuring apparatus and a method for operating the position measuring apparatus which are scalable in a simple manner to extend a measurement section.

The object is solved by she features specified in the two independent device claims or in the independent method claim respectively.

### DISCLOSURE OF THE INVENTION

The position measuring apparatus according to the invention for measuring the position of an electrically conductive measurement object which is able to be displaced over a measurement section, along which coils are positioned, provides an odd number of coils, wherein excitation coils are positioned at the odd positions, said excitation coils are flowed through by a alternating excitation current which is predefined to be in phase opposition from excitation coil to excitation coil, such that the alternating magnetic fields generated by the alternating excitation currents induce eddy currents in the electrically conductive measurement object when the measurement object moves past the excitation coils, and wherein a measurement coil is positioned at at least one even position between two excitation coil, said measurement coil providing a measurement alternating voltage induced via the measurement object, which is induced when the measurement object moves past the at least one measurement coil by the eddy currents flowing in the measurement object. A determination of the position of the measurement object is provided on the basis of the at least one measurement alternating voltage.

According to another embodiment of the position measuring apparatus according to the invention for measuring the position of an electrically conductive object which is able to be displaced over a measurement section, along which coils are positioned, an even number of coils is provided. The coils at the odd positions and in chronological order at the even positions are alternately connected as excitation coils which are flowed through respectively by a alternating excitation current which is provided to be in phase opposite from excitation coil to excitation coil by means of a switching device, such that the alternating magnetic fields generated by the alternating excitation currents induce eddy currents in the electrically conductive measurement object when the measurement object moves past the excitation coils, that at least one coil at an even position and in chronological order at an odd position is alternately connected as a measurement coil between two excitation coils by the switching device, said measurement coils providing induced measurement alternating voltages respectively via the measurement object, which is induced when the measurement object moves past the at least one measurement coil by the eddy currents flowing in the measurement object.

In this embodiment of the position measuring apparatus according to the invention, depending on the work cycle with which the switching occurs, the coil lying on the outer edge on a side of the measurement section and alternately the coil lying on the outer edge on the other end of the measurement section is connected to be without function respectively. A determination of the position of the measurement object is provided for this embodiment of the position measuring apparatus according to the invention on the basis of the measurement alternating voltages which are provided in chronological order by two, four or several even-numbered measurement coils.

A first substantial advantage of the position measuring apparatus according to the invention lies in that the measurement section can be extended at will by the arrangement of further sensor units which contain two excitation coils controlled in phase opposition and a measurement coil positioned between the two excitation coils respectively.

A further advantage lies in that a simple and inexpensive measurement object, the position of which is to be measured, can be used which must be electrically conductive at least only on its surface. Magnetisable, in particular ferromagnetic measurement objects are not required, but can be used likewise. The eddy currents induced by the alternating magnetic fields of the excitation coils in the measurement object induce, for their part, a measurement alternating voltage in the measurement coils due to the alternating magnetic field surrounding the eddy currents respectively, said alternating voltage being used to determine the position of the measurement object.

Due to the measurement principle, the frequency of the excitation currents can be provided to be comparatively high, whereby a high provision rate of measurement results can be achieved.

The term “position” used in the present application means, simultaneously, a displacement, a removal, a distance, an angle and similar.

Advantageous developments and embodiments of the position measuring apparatus according to the invention are the subject matter of the dependent claims respectively.

One embodiment provides that the coils are positioned in a row along the measurement section one next to the other potentially in a straight line, and that the measurement object is arranged to be linearly displaceable along the front side of the coils. Alternatively to a straight measurement section, however, a curved measurement section can also be provided.

One embodiment provides that the coils are implemented as annular coils and that the measurement object is arranged to be displaceable in the central opening of the annular coils. Depending on the geometric design on the one hand of the opening of the annular coils, and on the other hand that of the measurement object, a curved measurement section can also be provided for this arrangement as an alternative to a straight-line measurement section.

As a specific embodiment of a curved measurement section, a circle can be provided, wherein the coils are arranged on a circle periphery along the measurement section one next to the other. Due to a rotationally moveable arrangement of the measurement object, an embodiment of the position measuring apparatus according to the invention as an angle measuring apparatus is obtained.

Here the coils can be aligned perpendicularly to the rotational axis or centre line of the circle and the measurement object can be arranged to be rotationally moveable on an inner or outer circle periphery with regard to the coils.

Alternatively, it is possible that the coils are aligned perpendicularly[parallel?] to the rotational axis or central line of the circle and that the measurement object is arranged to be rotationally moveable on an inner or outer circle periphery with regard to the coils.

Other advantageous embodiments relate to potentially provided coil cores. According to one embodiment, U-shaped coil cores are provided. According to an alternative embodiment, the coil cores are designed to be E-shaped, wherein the coil windings are preferably arranged on the central E-arm.

A further advantageous embodiment provides that, for the provision of the alternating excitation current, an oscillator having direct digital synthesis and a subordinate voltage/current converter are provided. Such an oscillator can largely be implemented with software which can be changed to different frequencies without a great effort. Alternatively, an LC oscillator can be provided in the case of which the excitation coils form at least one part of the inductance respectively.

The possibility of determining the frequency of the alternating excitation current at a comparatively high value has already been explained. The frequency of the alternating excitation current preferably ranges from 100 kHz to 10 MHz. Alternatively to an electrically conductive, non-magnetisable measurement object, an electrically conductive, magnetisable, preferably ferromagnetic, measurement object can be provided as measurement object.

The method according to the invention for operating the position measuring apparatus is based on at least two measurement coils being provided. For each measurement coil, a signal course of the voltage of the measurement alternating voltage demodulated with the correct sign results when the measurement object moves past. A certain phase position is allocated to each measurement coil or to each signal course. A quadrature signal pair is calculated as the sum of the products of the voltages which are obtained from the measurement alternating voltages provided by the measurement coils by demodulation with the correct sign, and sine functions having a phase position which is allocated to the signal courses respectively, and as the sum of the products of the voltages and cosine functions, likewise having the phase position which is allocated to the signal courses respectively. The position of the measurement object is determined from the phase of the two quadrature signals.

With regard to the signal course of the voltage of the measurement alternating voltage demodulated with the correct sign when the measurement object moves past the at least one measurement coil, it has been determined that the quadrature modulation or quadrature demodulation intrinsically known from communications technology is particularly suitable, in particular in the scope of the multi-phase quadrature demodulation according to the invention, for determining the position of the measurement object with regard to the coil arrangement from the alternating voltages of at least two measurement coils.

One advantageous embodiment of the method according to the invention provides that the range corresponding to at least one signal course which occurs when the measurement object moves past the measurement coil, is adjusted with regard to the range of an adjacent signal course. With this measure, a linearization can be achieved.

In particular, a linearization by means of a determination of the phase positions allocated to the signal courses can be carried out, on which phase positions the determination of the quadrature signal pair is based.

One advantageous embodiment of the method according to the invention provides the stipulation for envelope factors. Here, the signal courses are weighted using envelope factors respectively in such a way that the signal courses which have been gained from the measurement alternating voltages of the measurement coils by demodulation with the correct sign, which are positioned at the ends of the measurement section, are weighted to be lower than the signal courses which have been gained from the measurement alternating voltages of those measurement coils by demodulation with the correct sign, which are positioned in the centre of the measurement section. With these measures, in particular negative influences on the measured position of the measurement object wish regard to the coil arrangement are minimised at the edge regions of the coil arrangement.

Further advantageous developments and embodiments of the position measuring apparatus according to the invention and of the method according to the invention for operating the position measuring apparatus arise from the description below.

Exemplary embodiments of the invention are depicted in the drawings and are explained in more detail in the description below.

### BRIEF DESCRIPTION OF THE FIGURES

FIG. 1 shows a sensor unit of a position measuring apparatus according to the invention,

FIG. 2 shows a signal course which is obtained when a measurement object moves past a measurement section of the sensor unit shown in FIG. 1,

FIG. 3 shows a block diagram of a circuit arrangement for providing an excitation current for excitation coils of the sensor unit,

FIG. 4 shows a block diagram of an alternative circuit arrangement for providing an excitation current for excitation coils of the sensor unit,

FIG. 5 shows an embodiment of the coils of the sensor unit as annular coils,

FIG. 6 shows an embodiment in which the coils of the sensor unit are positioned along a curved measurement section,

FIG. 7 shows an embodiment of a position measuring apparatus according to the invention in which a plurality of excitation coils and measurement coils are positioned alternately one next to the other,

FIG. 8 shows a plurality of signal courses which are obtained when a measurement object moves past a measurement section,

FIG. 9 shows an embodiment of a position measuring apparatus according to the invention in which a plurality of excitation coils and measurement coils are positioned one next to the other which are designed as annular coils respectively,

FIG. 10a shows an embodiment of a position measuring apparatus according to the invention in which a plurality of coils is arranged one next to the other which are connected in chronological order alternately as excitation coils and measurement coils,

FIG. 10b shows an even number of coils which are connected alternately as excitation coils and measurement coils according to a fixedly predetermined pattern,

FIG. 10c shows the signal courses obtained by measurement voltages which provide the coils connected as measurement coils of the coil arrangement shown in FIG. 10b,

FIG. 10d shows the wiring provided in a first work cycle of the coil arrangement shown in FIG. 10b,

FIG. 10e shows the signal courses obtained from the measurement voltages provided in the measurement coils active in the first work cycle,

FIG. 10f shows the wiring provided in a second work cycle of the coil arrangement shown in FIG. 10b,

FIG. 10g shows the signal courses obtained from the measurement voltages provided in the measurement coils active in the second work cycle,

FIG. 11 shows an embodiment of a position measuring apparatus according to the invention in which the coils are positioned on a circle periphery of a circular measurement section and are aligned in the radial direction towards the rotational axis of the circle,

FIG. 12 shows an embodiment of a position measuring apparatus according to the invention in which the coils are positioned on a circle periphery of a circular measurement section and are aligned in the axial direction towards the rotational axis of the circle,

FIG. 13 shows an embodiment of coils having U-shaped coil cores,

FIG. 14 shows an embodiment of coils having E-shaped coil cores,

FIG. 15a shows the voltages obtained from three measurement coils when the measurement object moves past the coils,

FIG. 15b shows the quadrature signals determined from the voltages shown in FIG. 15a,

FIG. 15c shows a functional connection between the position determined from the quadrature signals shown in FIG. 15b and the actual position of the measurement object,

FIG. 16a shows the voltages obtained from the measurement coils connected alternately in chronological order when a measurement object moves past the coils,

FIG. 16b shows the quadrature signals determined from the voltages shown in FIG. 16a,

FIG. 16c shows a functional connection between the position determined from the quadrature signals shown in FIG. 16b and the actual position of the measurement object,

FIG. 17a shows the voltages obtained by five measurement coils whose amplitude lies non-symmetrically with regard to the zero-line.

FIG. 17b shows the quadrature signals determined from the voltages shown in FIG. 17a,

FIG. 17c shows a functional connection between the position determined from the quadrature signals shown in FIG. 17b and the actual position of the measurement object,

FIG. 18a shows voltages obtained from a plurality of measurement coils and weighted with random functions,

FIG. 18b shows the quadrature signals determined from the voltages shown in FIG. 18a,

FIG. 18c shows a functional connection between the position determined from the quadrature signals shown in FIG. 18b and the actual position of the measurement object,

FIG. 19a shows the voltages obtained from a plurality of measurement coils and weighted with a Gaussian course-shaped function,

FIG. 19b shows the quadrature signals determined from the voltages shown in FIG. 19a,

FIG. 19c shows a functional connection between the position determined from the quadrature signals shown in FIG. 19b and the actual position of the measurement object,

FIG. 20a shows the voltages obtained from a plurality of measurement coils,

FIG. 20b shows the voltages shown in FIG. 20a, wherein at least one voltage has been corrected with regard to the amplitude with respect to at least one adjacent voltage,

FIG. 20c shows the voltages shown in FIG. 20a which have been multiplied respectively by an enveloping coefficient, and

FIG. 20d shows a functional connection between the position determined from the in FIGS. 20b and 20c respectively and the actual position of the measurement object.

### DETAILED DESCRIPTION OF THE EXEMPLARY EMBODIMENTS

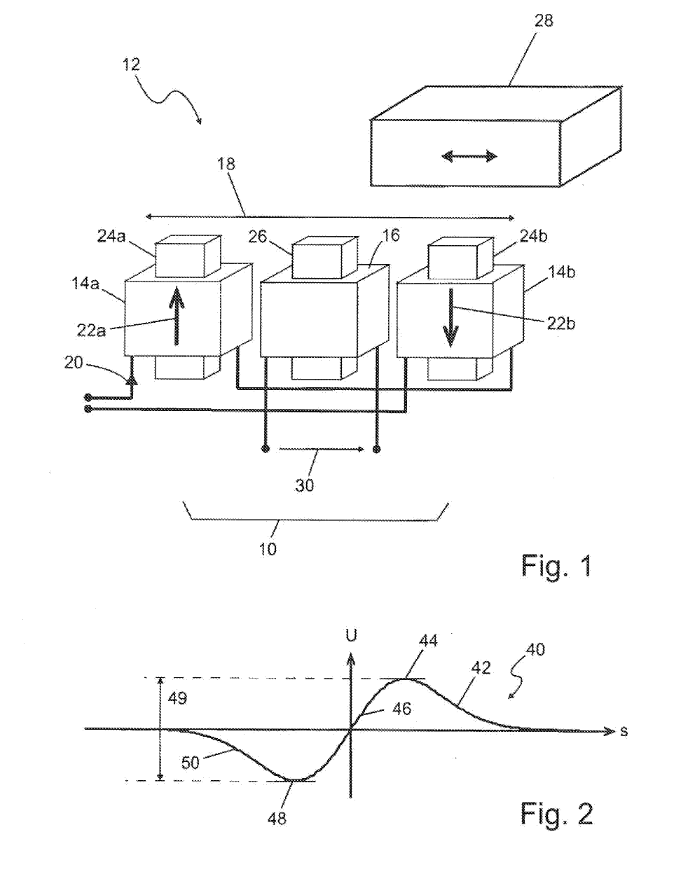

FIG. 1 shows a sensor unit 10 of a position measuring apparatus 12 according to the invention, which contains three coils 14a, 14b, 16 which are positioned substantially equidistantly along a straight-line measurement section 18. The two outer coils 14a, 14b, so the left-hand and the right-hand coils 14a, 14b, of the sensor unit 10 are excitation coils which are flowed through by a excitation current 20. The excitation coils 14a, 14b are connected in such a way that magnetic fields 22a, 22b directed in opposite directions are generated which are aligned substantially perpendicularly with regard to the measurement section 18.

An alternating current is provided as a excitation current 20, such that the magnetic fields 22a, 22b are alternating magnetic fields 22a, 22b. The frequency of the excitation current 20 typically ranges from 100 kHz to a few MHz, for example up to 10 MHz. The alternating magnetic fields 22a, 22b directed in opposite directions are coupled to the central coil 16 which serves as a measurement coil 16. In the exemplary embodiment shown, all coils 14a, 14b, 16 contain a rod-shaped magnetic core 24a, 24b, 26 respectively which consists of a magnetisable, preferably a ferromagnetic, material, for example iron.

The position measuring apparatus 12 according to the invention detects the position of a measurement object 28 with regard to the sensor unit 10, said object moving along the measurement section 18. A substantial advantage of the position measuring apparatus 12 according to the invention is that the measurement object 28 can be implemented as a simple, electrically conductive measurement object 28. For example, an electrical insulator can be provided as a measurement object 28 which is provided with an electrically conductive coating. For example, aluminium, copper, tin and similar are suitable as a non-ferromagnetic material. Alternatively, the measurement object 28 can also be produced from a ferromagnetic material such as iron. Due to the electrical conductivity, eddy currents are induced in particular on the surface of the measurement object 28 due to the alternating magnetic fields 22a, 22b, said eddy currents being surrounded on their part by a magnetic excitation which is not shown in more detail.

Without a measurement object 28 present in the region of the sensor unit 10, a part of the alternating magnetic fields 22a, 22b directed in opposite directions of the two excitation coils 14a, 14b is coupled to the measurement coil 16 and occurs as a background value. Under the condition that the structure is implemented to be at least approximately symmetrical and the alternating magnetic fields 22a, 22b directed in opposite directions of the excitation coils 14a, 14b have, as a consequence, at least approximately the same magnetic induction, a measurement alternating voltage 30 provided by the measurement coil 16 is at least approximately equal to zero. The alternating magnetic field 22a of the excitation coil 14a positioned on the left-hand side induces a partial measurement alternating voltage in the measurement coil 16 having a first polarity and the alternating magnetic field 22b of the excitation coil 14b positioned on the right-hand side likewise generates a partial measurement alternating voltage in the measurement coil of the same amount, but of different polarity, such that the resulting measurement alternating voltage 30 of both induced partial measurement alternating voltages is at least approximately equal to zero.

An alignment within the sensor unit 10 can occur in that the positions of the individual coils 14a, 14b, 16 are adjusted. In principle it is already sufficient to only adjust the position of the measurement coil 16. Later, a purely numerical alignment is described in which, on the one hand, the range 49 recorded in FIG. 2 between the positive signal maximum 44 and the negative signal maximum 48 are aligned and, on the other hand, the ranges 49 between several signal courses 40 are aligned.

The background value can both, as already described, be adjusted to zero mechanically, and also electronically by means of a differential amplifier or subtracted numerically after a digitalisation.

In FIG. 2, the voltage U of a signal course 40 is shown which can be obtained from the measurement alternating voltage provided by the measurement coil 16.

The parts shown in FIG. 2 which correspond to the parts shown in FIG. 1 are provided with the same reference numbers respectively. This convention also applies to the Figures below.

To obtain the voltage U of the signal course 40, the measurement alternating voltage 30 is demodulated with the correct polarity. The signal course 40 is depicted depending on the position s of the measurement object 28. The signal course 40 results if the electrically conductive measurement object 28 moves along the measurement section 18. For the demodulation with the correct polarity, a cycle signal can be used as a reference signal, whose frequency is identical to the frequency of the excitation current 20.

If the measurement object 28 is approached by the right-hand side of the measurement coil 16, as depicted in the exemplary embodiment according to FIG. 1, the alternating magnetic excitation 22a of the right-hand excitation coil 14b induces eddy currents in the measurement object 28. Since these eddy currents lie outside of the symmetry of the sensor unit 10, the electromagnetic equilibrium, of the sensor unit 10 is disrupted and a signal increase 42 occurs in the signal course 40.

If the measurement object 28 is moved further to the left in the direction of the measurement coil 16, the signal course 40 firstly increases further, because a larger surface of the measurement object 28 is exposed to the alternating magnetic excitation 22b of the right-hand excitation coil 14b and the eddy currents or the magnetic alternating magnetic fields accompanying the eddy currents occur closer in the region of the measurement coil 16.

If the measurement object 28 moves further to the left in the direction of the left excitation coil 14a, eddy currents are also increasingly generated in the measurement object 28 by the alternating magnetic excitation 22a of the left-hand excitation coil 14a which, however, due to the opposite orientation of the alternating magnetic excitation 22a, lead to magnetic fields directed in opposite directions with regard to the alternating magnetic excitation 22b of the right-hand excitation coil 14b and therefore partially compensate for the eddy currents induced by the right-hand excitation coil 14b. After the passing of a first signal maximum 44 corresponding to a first positive amplitude, a signal drop 46 therefore occurs.

A state of equilibrium in which the measurement alternating voltage 30 and the voltage U are equal to zero and the signal course 40 passes the zero line occurs if the measurement object 28 assumes a position s which lies in the centre of the sensor unit 10.

If the measurement object 28 moves further to the left in the direction of the left-hand excitation coil 14a, the alternating magnetic excitation 22a of the left-hand excitation coil 14a predominates, such that the signal drop 46 continues with a now negative measurement alternating voltage 30 demodulated with the correct sign.

The influence of the alternating magnetic excitation 22a of the left-hand excitation coil 14a increasingly strengthens while the influence of the alternating magnetic excitation 22b of the right-hand excitation coil 14b increasingly reduces until a second, negative signal maximum 48 is reached.

If the measurement object 28 is moved out from the sensor unit 10 to the left along the measurement section 18, a signal increase 50 occurs again after the negative signal maximum 48. If the measurement object 28 is moved out from the detection region of the sensor unit 10 to the left, the signal course 40 falls again to the zero line.

In the region between the first signal maximum 44 and the second signal maximum 48 of opposite polarity, the monotonously decreasing signal decrease 46 occurs which becomes a corresponding signal increase during a movement of the measurement object 28 along the measurement section 18 from the left side in the direction of the right side. In this region, the voltage U gained from the measurement alternating voltage 30 can be clearly allocated to a certain position s of the measurement object 28.

As already explained, due to mechanical inaccuracies, a background value can occur. The background value can be both, as already described, adjusted mechanically to zero and electronically by means of a differential amplifier or subtracted numerically after a digitalisation.

Later, a purely numerical alignment is described in which, on the one hand, the range 49 recorded in FIG. 2 between the positive signal maximum 44 and the negative signal maximum 48 and, on the other hand, the ranges 49 between several signal courses 40 are aligned.

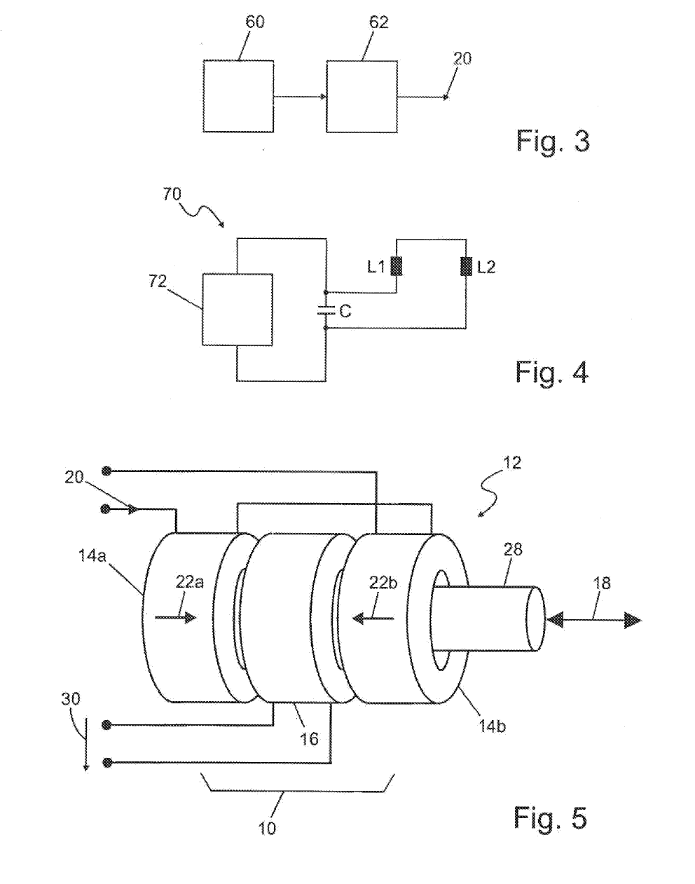

FIG. 3 shows a block diagram of a preferred embodiment of a circuit arrangement for providing the excitation current 20. Preferably an oscillator 60 is provided with direct digital synthesis (DDS) to which a voltage/current converter 62 is connected downstream, which provides an alternating current as a excitation current 20. The oscillator 60 can be implemented predominantly using software such that an adaptation, required if necessary, of the frequency of the excitation current 20 can be carried out simply and quickly in the scope of an application of the position measuring apparatus 12 according to the invention.

Alternatively, the excitation current 20 can be provided with an LC oscillator 70. A corresponding block diagram of a circuit arrangement is shown in FIG. 4. The inductances L1, L2 of the two excitation coils 14a, 14b are supplemented with a capacitor C to form an LC oscillating circuit which is stimulated into oscillation of the predetermined frequency by an oscillating circuit 72.

Since the measurement object 28 is preferably implemented as a non-magnetisable measurement object 28, the frequency range of the excitation current 20 can be determined to be comparatively high and, for example, lies above 100 kHz and can extend until, for example, 10 MHz. In this frequency range, the oscillator 60 or the LC oscillator 70 can be implemented with simple circuit means. A particular advantage of the comparatively high frequency range of the excitation current 20 lies in that the position s of the measurement object 28 can be determined comparatively quickly from the measurement alternating voltage 30 or from the voltage U.

Purely in principle, a conductive, magnetisable, preferably ferromagnetic, material can be provided as a measurement object 28.

In FIG. 5, a coaxial embodiment is shown as an exemplary embodiment of the position measuring apparatus 12 according to the invention. The coils 14a, 14b, 16 of the sensor unit 10 are implemented as annular coils which are wound around the measurement section 18 respectively. The measurement object 28 is moved along the measurement section 18 in the central opening of the coils 14a, 14b, 16. The excitation current 20 leads to the provision of alternating magnetic fields 22a, 22b, originating from the two outer excitation coils 14a, 14b which are aligned to lie predominantly in parallel to the measurement section 18 at least in the region of the sensor unit 10. The alternating magnetic excitation 22a of the left-hand excitation coil 14a and the alternating magnetic excitation 22b of the right-hand excitation coil 14b are aligned in opposite directions again.

If it is ensured chat the measurement object 28 is freely moveable in the central opening of the coils 14a, 14b, 16, alternatively to the depicted straight-line measurement section 18, a curved measurement section 18 can also be provided.

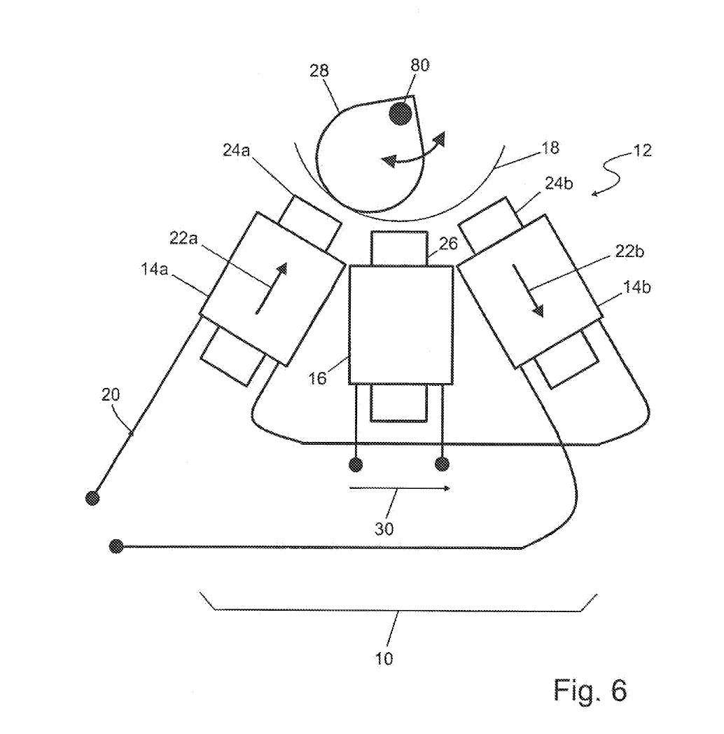

In FIG. 6, an embodiment of the position measuring apparatus 12 according to the invention is shown which is provided for the position measurement of a measurement object 28 which is moveable in a rotating manner around a rotational axis 80. The measurement section 18 is, in this case, preferably a circular arc. The rotational angle of the measurement object 28 can be measured.

The excitation current 20 leads to the provision of alternating magnetic fields 22a, 22b, originating from the two outer excitation coils 14a, 14b, wherein in this exemplary embodiment, the alternating magnetic fields 22a, 22b are orientated substantially perpendicularly to the rotational axis 80. The alternating magnetic excitation 22a of the left excitation coil 14a and the alternating magnetic excitation 22b of the right excitation coil 14b are also here aligned in opposite directions again. In the shown exemplary embodiment, it is again assumed that the coils 14a, 14b, 16 have rod-shaped magnetic cores 24a, 24b, 26, preferably ferromagnetic magnetic cores 24a, 24b, 26 respectively.

Purely in principle, it is possible to deviate from the circular design and to provide any predetermined, curved measurement section 18.

Only one sensor unit 10 has been shown from the position measuring apparatus 12 according to the invention in FIGS. 1, 5 and 6 respectively. A substantial advantage of the position measuring apparatus 12 according to the invention lies in that the measurement section 18 can be expanded by a periodic continuation of the sensor unit 10 in a particularly simple manner.

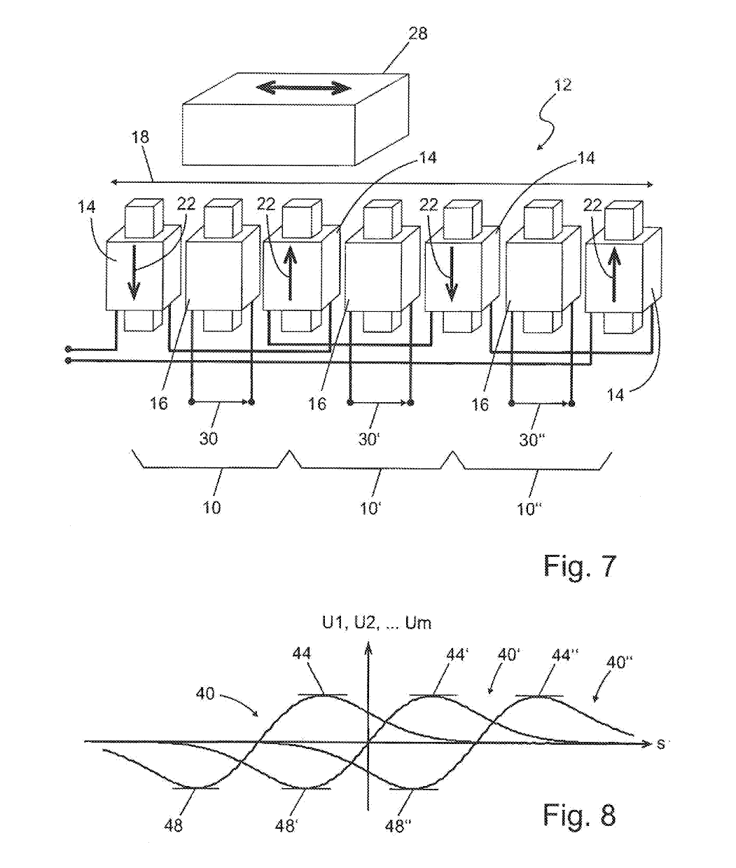

A corresponding exemplary embodiment which expands the design of the position measuring apparatus 12 shown in FIG. 1 is shown in FIG. 7. In an expansion of the position measuring apparatus 12 according to the invention, 2 coils are supplemented respectively, and indeed a measurement coil 16 and a excitation coil 14 in an alternating manner. Sensor units 10, 10′, 10″ nested one inside the other result, wherein the right-hand excitation coil 14 according to FIG. 1 becomes the left-hand excitation coil 14 in the next sensor unit 10′. The right-hand excitation coil 14 of the next sensor unit 10′ correspondingly becomes the left-hand excitation coil 14 of the next but one sensor unit 10″, which is delimited on the right-hand side by the last excitation coil 14. The measurement coils 16 lie between the excitation coils 14 respectively. The position measuring apparatus 12 has an odd number or coils 14, 16 such that the total number k can be specified with

k=2m+1

wherein m is the number of measurement coils 16.

Purely in principle, the arrangement shown in FIG. 7 can be periodically supplemented by two further coils 14, 16 respectively in any manner. Corresponding to the number of measurement coils 16, correspondingly more measurement alternating voltages 30, 30′, 30″ are available.

FIG. 8 shows three possible signal courses 40, 40′, 40″ gained from the measurement alternating voltages 30, 30′, 30″ by means of demodulation with the correct polarity, which are obtained using the periodically supplemented position measuring apparatus 12. The signal courses 40, 40′, 40″ which are gained from the measurement voltages 30, 30′, 30″ demodulated with the correct sign, correspond to the voltages U1, U2, . . . Um respectively. If, as described by means of FIG. 1, the measurement object 28 is moved, originating from the right-hand side in the direction of the left-hand side along the measurement section 18, the first signal course 40 of the sensor unit 10, shown in FIG. 8, corresponds to the signal course 40 shown in FIG. 2. In an arrangement having three measurement coils 16, three signal courses 40, 40′, 40″ are obtained correspondingly.

The signal courses 40, 40′, 40″ have positive maxima 44, 44′, 44″ and negative maxima 48, 48′, 48″ respectively, between which a range 49 occurs respectively, as recorded in FIG. 2.

Depending on potentially present mechanical inaccuracies of the position measuring apparatus 12 according to the invention, a background value can occur—as has been explained multiple times already—which can be detected when the measurement object 28 is not present. Preferably, instead of or even in addition to an alignment of the entire arrangement, an electronic correction is provided. Here, the background value detected without the measurement object 28 is removed from the signal courses 40, 40′, 40″ of the voltage of the measurement alternating voltages U1, U2, . . . Um demodulated with the correct sign, for example by means of a differential amplifier.

Preferably, a normalisation is furthermore provided in which the range 49 is compensated for or normalised between the positive maxima 44, 44′, 44″ and negative maxima 48, 48′, 48″ belonging together.

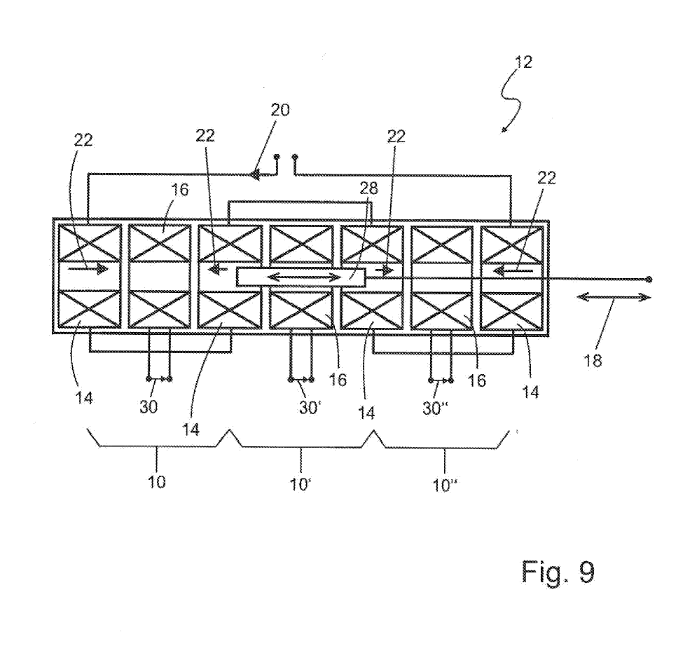

FIG. 9 shows a periodic supplementation of the position measuring apparatus 12 according to the invention of the exemplary embodiment shown in FIG. 5, in which the excitation coils 14 and the measurement coils 16 are wound around the measurement section 18 in a circle, such that the alternating magnetic fields 22 are orientated in parallel to the measurement section 18 respectively. The measurement object 28 is moved along the measurement section 18 in the central opening of the coils 14, 16. Purely in principle, the measurement section 18 does not have to run in a straight line, but can also fundamentally have a predetermined curve here. For this it is required that the measurement object 28 can follow the curve in the central opening of the coils 14, 16 without hindrance.

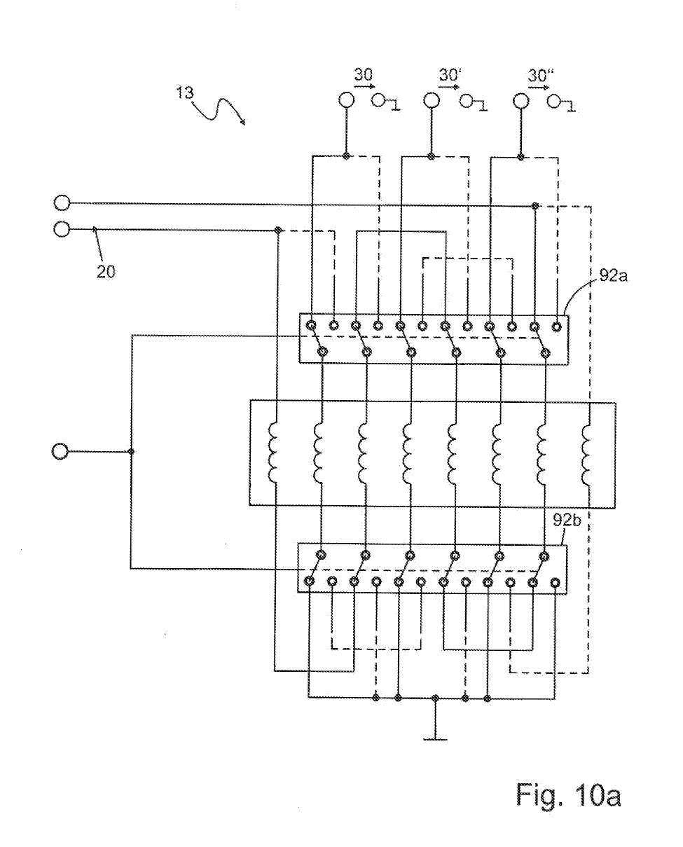

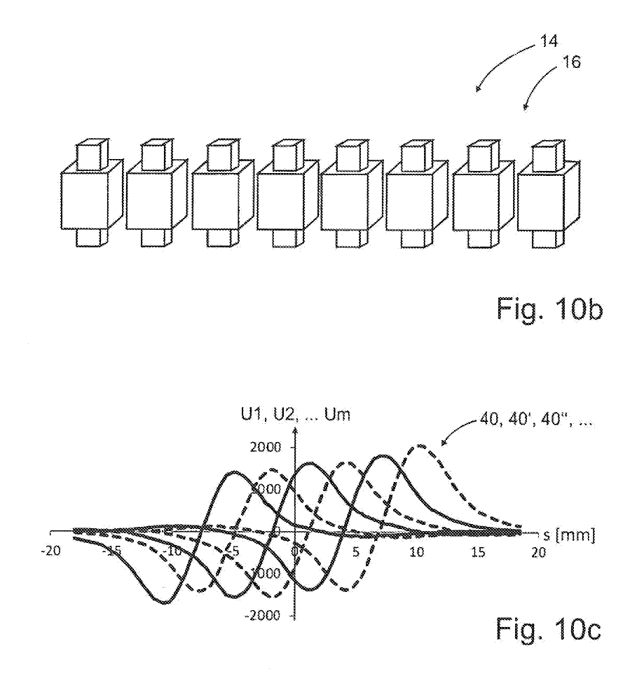

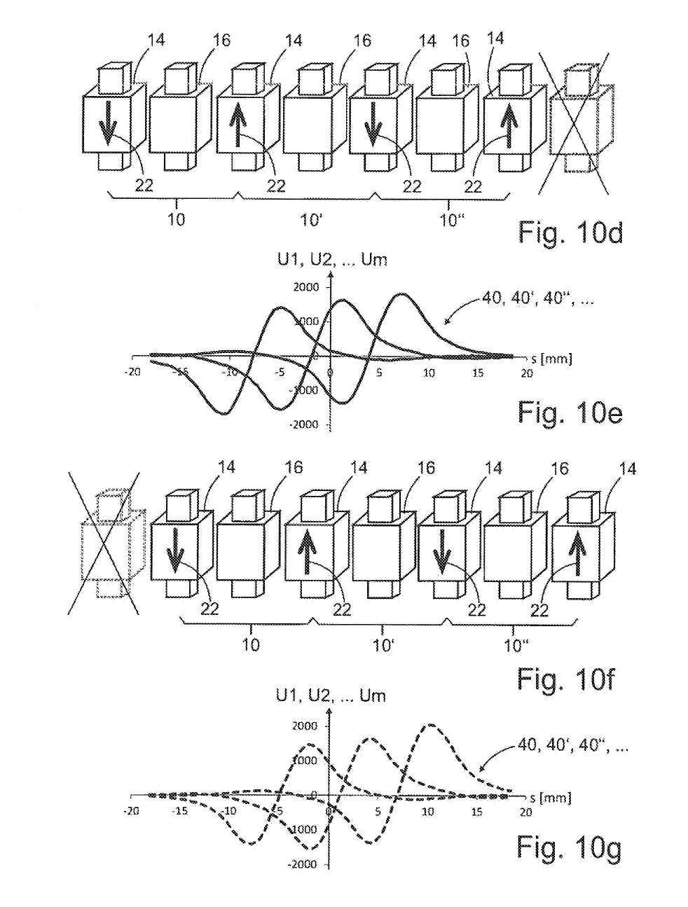

FIG. 10a shows an embodiment according to the invention of a position measuring apparatus 13 in which the two work cycles are provided in which the functions as excitation coils and measurement coils are allocated to different coils respectively. A higher spatial resolution can thereby be achieved with fewer coils. This embodiment of the position measuring apparatus 13 according to the invention contains an even number of coils. The total number K of the coils is provided by:

K=M+2

wherein M is the number of available measurement alternating voltages 30, 30′, 30″.

FIG. 10b shows the coils 14, 16 of the coil arrangement and FIG. 10c shows the signal courses 40, 40′, 40″, . . . gained from the measurement alternating voltages 30, 80′, 30″ provided by coils 16 connected as measurement coils respectively.

Also in this embodiment, three coils 14, 16 arranged one next to the other form a sensor unit 10, 10′, 10″ respectively.

FIG. 10d shows the situation in a first work cycle. In the first work cycle, the coil lying on the right-hand outer edge is to be connected to be without function. The remaining seven coils 14, 16 are connected according to the exemplary embodiment shown in FIG. 7. FIG. 10e shows the signal courses 40, 40′, 40″, gained from the measurement alternating voltages provided by the three measurement coils 16 according to FIG. 10d, said signal courses being recorded by solid lines, and FIG. 10g shows the signal courses 40, 40′, 40″, gained from the measurement alternating voltages provided by three measurement coils 16 according to FIG. 10f, said signal courses being recorded by dashed lines. The signal courses 40, 40′, 40″, shown in FIGS. 10e and 10g together result in the signal courses 40, 40′, 40″, . . . shown in FIG. 10c, wherein the signal courses depicted with solid lines are obtained in the first work cycle and the signal courses depicted with dashed lines are obtained in the second work cycle.

By switching the functions of the coils between the two work cycles, sensor units 10, 10′, 10″ locally shifted by a coil in chronological order result such that, therefore, an increased spatial resolution during the measuring of the position s with clearly reduced effort is achieved by using this embodiment of the position measuring apparatus 13 according to the invention.

The embodiment of the position measuring apparatus 13 according to the invention according to FIG. 10a is suitable in particular for periodic expansion of the curved embodiment of the measurement section 18 shown in FIG. 6. In particular, in the case of a rotationally symmetrical embodiment, a detection of the position or of the angle of the measurement object 28 occurs in a complete circle, wherein in this specific embodiment having an even number of coils 14, 16, measurement alternating voltages 30, 30′, 30″ . . . are obtained in a total range of 360°.

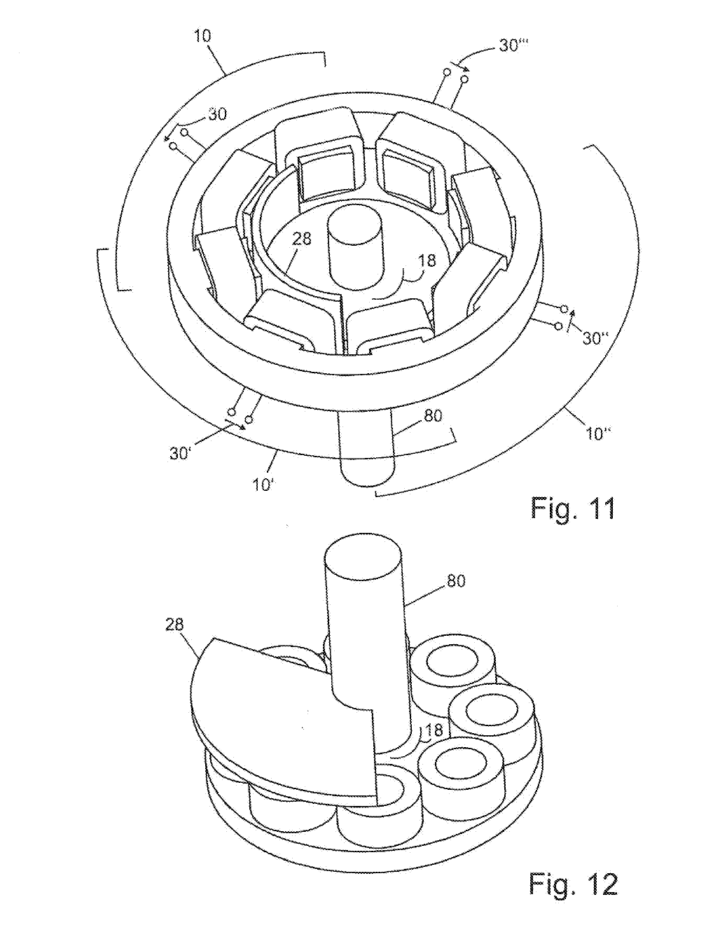

Corresponding exemplary embodiments are shown in FIGS. 11 and 12. In the embodiment shown in FIG. 11, the alternating magnetic fields are aligned to be substantially perpendicular to the rotational axis 80. In the exemplary embodiment shown in FIG. 12, the alternating magnetic fields, on the other hand, are orientated to be substantially parallel to the rotational axis 80.

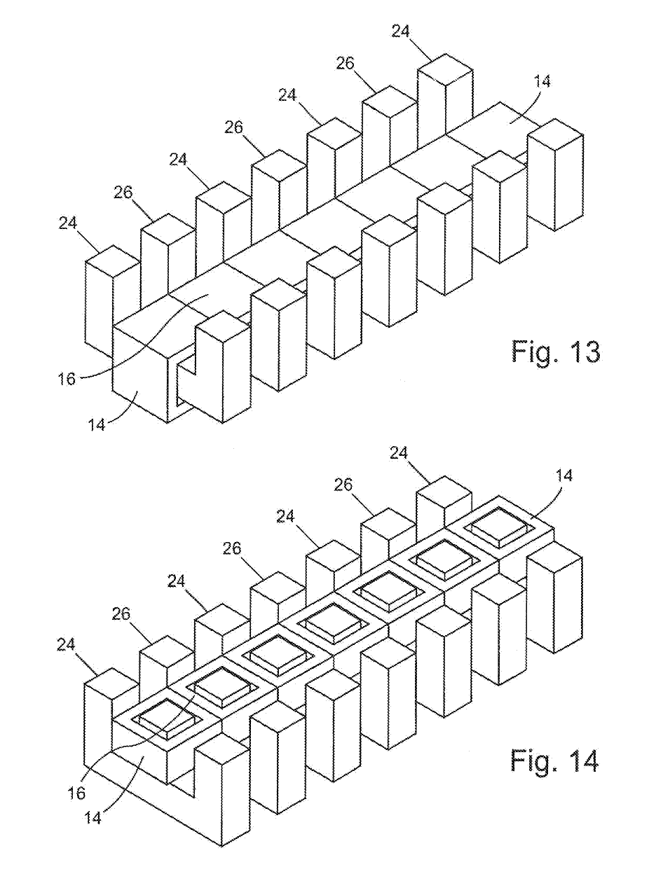

FIGS. 13 and 14 show alternative embodiments of the magnetic cores 24, 26 in comparison to the embodiments shown in FIGS. 1, 6 and 7 as rod-shaped magnetic cores 24a, 24b, 26.

In FIG. 13, a U-shaped embodiment of the magnetic cores 24, 26 is shown. The coils 14, 16 are arranged respectively on the arms of the U-shaped magnetic cores 24, 26.

In FIG. 14, an E-shaped embodiment of the magnetic cores 24, 16 is shown. The coils 14, 16 are arranged respectively on the central arm of the E-shaped magnetic cores 24, 26.

To determine the position s from the measurement alternating voltages 30, 30′, 30″ demodulated with the correct polarity, preferably a so-called multi-phase quadrature demodulation is suitable, which is described below in more detail. The range of the signal drop 46 of the signal course 40 in FIG. 2 and the comparative unspecified signal drops in the signal courses 40, 40′, 40″ according to FIG. 8 have a similarity with a section of a sine function. It has therefore been discovered that a multi-phase quadrature demodulation is particularly suitable in order to determine a measure s_Mess for the actual position s of the measurement object 28 along the measurement section 18.

Firstly, each measurement coil 16 of each sensor unit 10, 10′, 10″ . . . , or each signal course 40, 40′, 40″ . . . has a certain phase position which differ for example by 85° in the case of a plurality of measurement coils 16. It is required that the measurement signals 30, 30′, 30″ of the measurement coils 16 be demodulated with the correct sign in order to obtain the voltages U1, U2, . . . Um or the signal courses 40, 40′, 40″ shown in FIGS. 2 and 8. As already described, the background value is preferably eliminated and the range 49 between adjacent signal courses 40, 40′, 40″ is normalised.

The two analogous quadrature signals qₛᵢₙ, q_{cos} result from the following equations:

$${q}_{sin} = {\sum }_{i = 1}^{m} {U}_{i} cos ( ( i - \frac{1}{2} ( m + 1 ) ) \cdot Δ {ϕ}_{p} )$$

$${q}_{cos} = {\sum }_{i = 1}^{m} {U}_{i} sin ( ( i - \frac{1}{2} ( m + 1 ) ) \cdot Δ {ϕ}_{p} )$$

m number of measurement coils 16 or the signal courses 40, 40′, 40″
Δφₚ predetermined phase shift between two adjacent signal courses 40, 40′, 40″
U1, U2, . . . Um voltages of the signal courses 40, 40′, 40″, gained from the measurement alternating voltages 30, 30′, 30″ demodulated with the correct sign

The two analogous quadrature signals qₛᵢₙ, q_{cos} are therefore obtained as a linear combination of the voltages U1, U2, . . . Um of the signal courses 40, 40′, 40″ . . . , which have been obtained from the measurement alternating voltages 30, 30′, 30″ . . . demodulated with the correct sign, wherein the two quadrature signals qₛᵢₙ, q_{cos} are calculated as the sum of the products of the voltages U1, U2 . . . Um and sine functions having a phase position which is allocated to the signal courses 40, 40′, 40″ . . . respectively and as the sum of the products of the voltages U1, U2, . . . Um and cosine functions, likewise having the phase position which is allocated to she sensor units 10, 10′, 10″ or the measurement coils 16 or the signal courses 40, 40′, 40″, . . . respectively.

The position s_Mess is obtained from the position-dependent phase parameters of the quadrature signals qₛᵢₙ, q_{cos}, for example using the arc tangens function in the fourth quadrant. An ambiguity due to phase jumps by 360° can therefore be eliminated in a simple manner, because a certain signal course 40, 40′, 40″ clearly dominates depending on the actual position s of the measurement object 28 and therefore the position s can be allocated at least roughly to a certain signal, course 40, 40′, 40″.

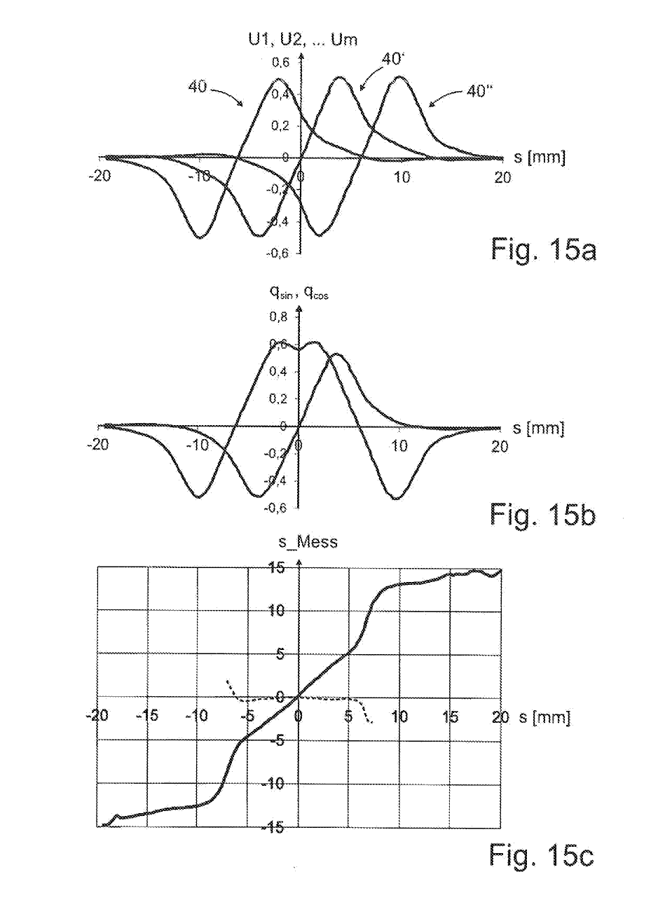

A position measurement on the basis of the multiphase quadrature demodulation is shown in FIGS. 15a, 15b and 15c. Underlying are three sensor units 10, 10′, 10″, wherein the length of the measurement section 18, measured between the centre points of the outer two excitation coils 14, amounts to approximately 20.8 mm. The three sensor units 10, 10′, 20″ together contain 7 coils. The mechanical period amounts to p=6.95 mm. FIG. 15a shows the signal courses 40, 40′, 40″ or the voltages U1, U2, . . . Um of the signal courses 40, 40′, 40″ depending on the actual position s of the measurement object 28 with regard to the measurement section 18. FIG. 15b shows the resulting two quadrature signals qₛᵢₙ, q_{cos} and FIG. 15c shows, with the solid line, the position s_Mess determined depending on the phase of the quadrature signals qₛᵢₙ, q_{cos} and, with the dashed recorded line, the deviation from the ideal linear characteristics between +/−7 mm.

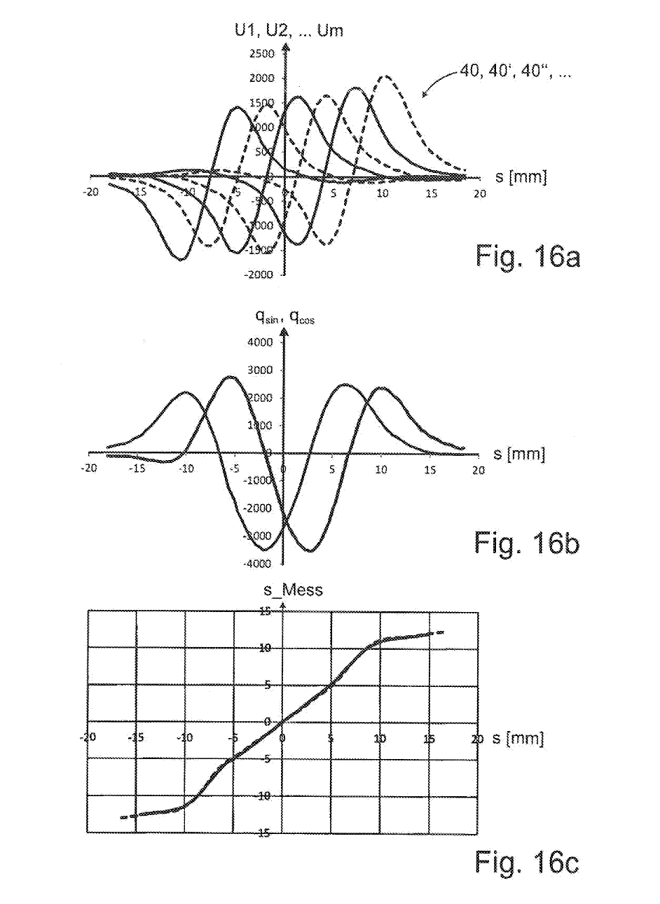

A further position measurement on the basis of the multiphase quadrature demodulation is shown in FIGS. 16a, 16b and 16c. Underlying are two×three sensor units 10, 10′, 10″, wherein the length of the measurement section 18, measured between the centre points of the outer two coils of the total coil system again amounts to 20.8 mm. The embodiment according to the invention of the position measuring apparatus 13 shown in FIG. 10 is to underlie, in which two groups of sensor units 10, 10′, 10″ which belong together are switched between in chronological order. The three alternately switched sensor units 10, 10′, 10″ together contain 8 coils. The mechanical period amounts to p=5.85 mm in both switching states, such that an effective distance between the effectively six measurement coils 16′ of 5.85 mm/2=2.93 mm results. The signal courses 40, 40′, 40″ obtained from the measuring alternating voltages 30, 30′, 30″ read in the first work cycle are depicted with solid lines, while the signal courses 40, 40′, 40″ obtained in the subsequent second work cycle from the locally shifted sensor units 10, 10′, 10″ are depicted with dashed lines. FIG. 16b shows the resulting two quadrature signals qₛᵢₙ, q_{cos} and FIG. 16c shows the position s_Mess determined with the solid line depending on the phase of the quadrature signals qₛᵢₙ, q_{cos}, at a distance of the measurement object 28 from the measurement coils 14, 16 of approximately 3.5 mm and the determined position s_Mess with the dashed recorded line, at a distance of approximately 1.5 mm. FIG. 16c proves the high insensitivity of the position measuring apparatus 12, 13 according to the invention compared to a variation of the distance of the measurement object 28 from the coils 14, 16.

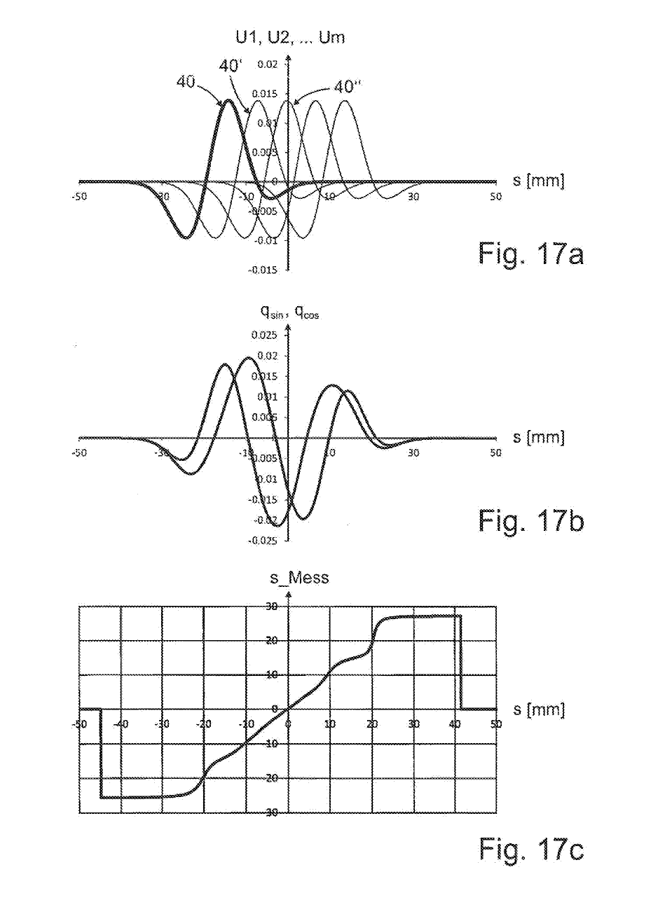

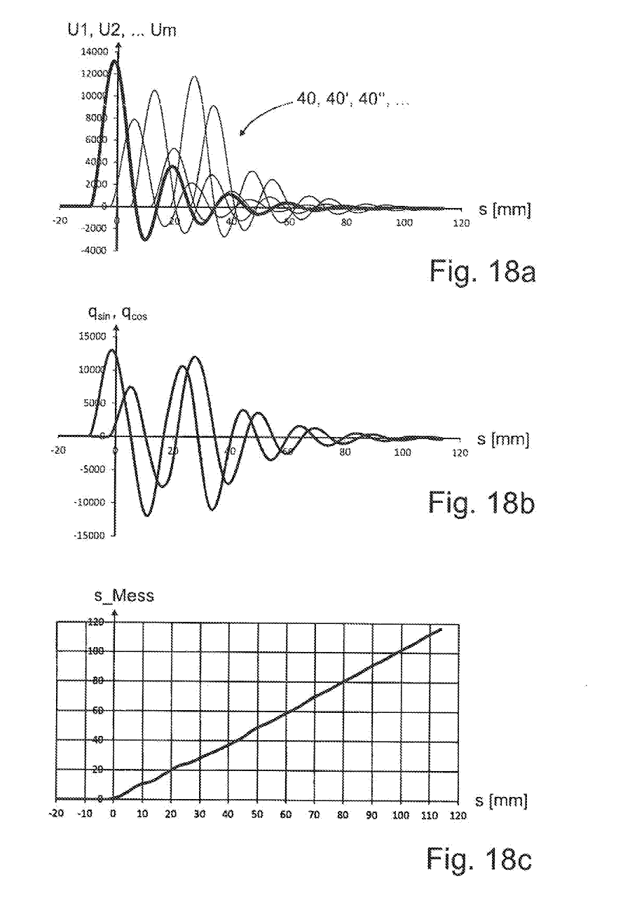

By means of the measurements shown in FIGS. 17 and 18, the robustness of the determination of the position s_Mess is clarified by means of the multiphase quadrature demodulation.

FIG. 17a shows, by way of example, the voltages U1, U2, . . . Um corresponding to five non-symmetrical signal courses 40, 40′, 40″ . . . which have been displaced depending on location with the offset of the corresponding sensor unit 10, 10′, 10″. FIG. 17b shows the resulting two quadrature signals qₛᵢₙ, q_{cos} and FIG. 17c shows the position s_Mess determined depending on the phase of the quadrature signals qₛᵢₙ, q_{cos}.

FIG. 18a shows, by way of example, the voltages U1, U2, . . . Um corresponding to a plurality of signal courses 40, 40′, 40″ . . . which have been multiplied by a random factor. FIG. 18b shows the resulting two quadrature signals qₛᵢₙ, q_{cos} and FIG. 18c shows the position s_Mess determined depending on the phase of the quadrature signals qₛᵢₙ, q_{cos}.

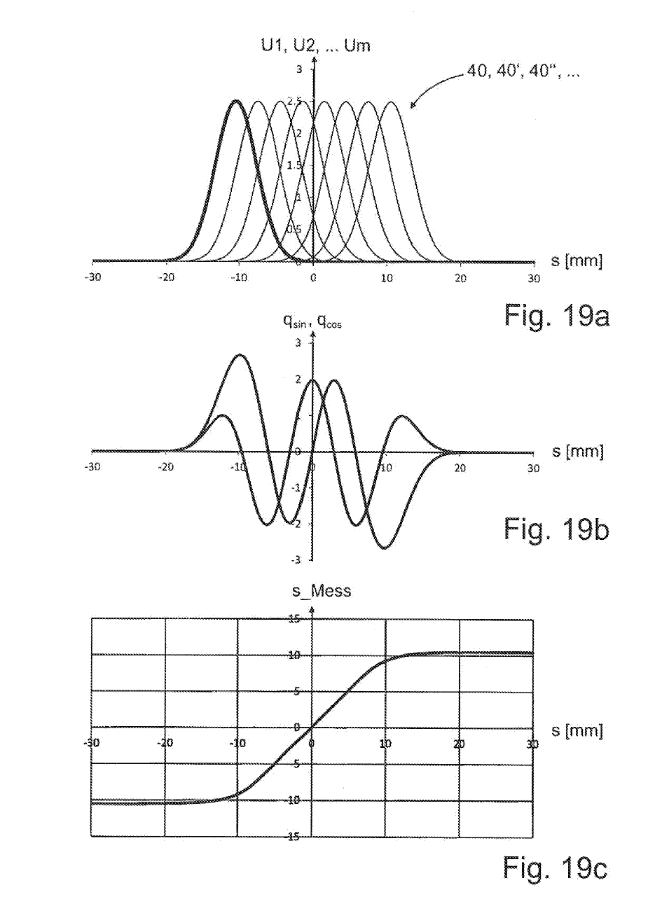

FIG. 19a shows, by way of example, the voltages U1, U2, . . . Um corresponding to a plurality of signal courses 40, 40′, 40″ . . . which have a Gaussian distribution-shaped envelope. The signal courses 40, 40′, 40″ . . . are symmetrical and have only one polarity, in the shown exemplary embodiment a positive polarity. The signal courses 40, 40′, 40″ . . . are displaced depending on location with the offset of the corresponding sensor unit 10, 10′, 10″. The offset should preferably be removed. FIG. 19b shows the resulting two quadrature signals qₛᵢₙ, q_{cos} and FIG. 19c shows the position s_Mess determined depending on the phase of the quadrature signals qₛᵢₙ, q_{cos}.

The shown examples prove the insensitivity with respect to errors in the position measuring apparatus 12, 13 according to the invention during the application of the multiphase quadrature demodulation to determine the position s_Mess of the measurement object 28.

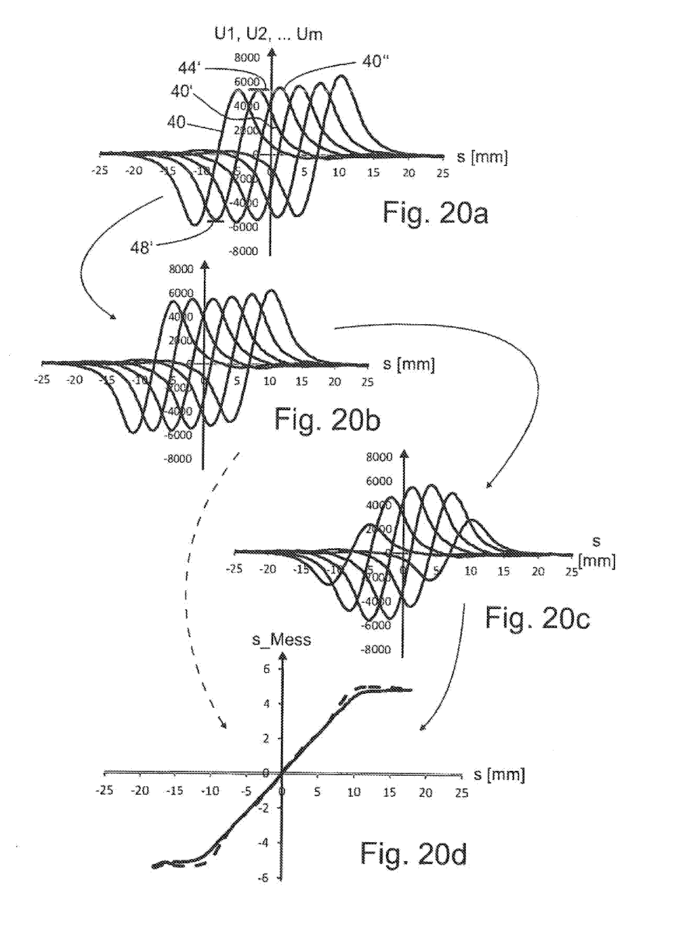

A particularly advantageous embodiment of the method according to the invention for determining the position s_Mess of a measurement object 28 using the position measuring apparatus 12, 13 according to the invention is explained by means of FIGS. 20a-20d.

The embodiment provides the use of an envelope factor cᵢ^{env} by which the voltages U1, U2, . . . Um corresponding to the signal courses 40, 40′, 40″ . . . are multiplied respectively. The envelope factors cᵢ^{env} are provided in such a way that the signal courses 40, 40′, 40″ . . . which are gained from the measurement coils 16 lying furthest at the ends of the position measuring apparatus 12, 13 according to the invention respectively are weighted to be lower and the signal courses 40, 40′, 40″ . . . obtained from the measurement coils 16 positioned in the centre of the measurement section 18 are weighted to be higher.

In FIG. 20a, by way of example, the voltages U1, U2, . . . Um are depicted corresponding to FIG. 16a. The second signal course 40′, counted from the left, is to have lower maxima 44′, 48′ than the adjacent signal courses 40, 40′. Besides the riddance of the voltages U1, U2, . . . Um from the background value, a normalisation is provided in which the range 49 not recorded in FIG. 20a between the maxima 44′, 48′ is aligned with respect to the adjacent voltages. The result is shown in FIG. 20b.

The result for the determination of the position s_Mess without the advantageous embodiment relating to the multiplication of the signal courses 40, 40′, 40″ . . . with the envelope factors cᵢ^{env} is depicted in FIG. 20d with the dashed line.

According to the advantageous embodiment, the signal courses 40, 40′, 40″ . . . shown in FIG. 20b, by way of example, are multiplied by the following envelope factors cᵢ^{env}

| i | cᵢ^{env} |
|---|---|
| 1 | 0.45 |
| 2 | 0.85 |
| 3 | 1.00 |
| 4 | 1.00 |
| 5 | 0.85 |
| 6 | 0.45 |

according to the formula:

U₁^{env}=U₁×cᵢ^{env},

wherein, with U₁, the voltages of the measurement alternating voltages 30, 30′, 30″ demodulated with the correct sign and provided by the measurement coils 16 are to be labelled corresponding to the signal courses 40, 40′, 40″.

The signal, courses resulting due to the weighting with the envelope factors cᵢ^{env} are shown in FIG. 20c.

The result of the position determination with the advantageous embodiment by multiplication of the signal courses 40, 40′, 40″, . . . with the envelope factors cᵢ^{env} is depicted in FIG. 20d with the solid line. It is evident therefrom that in particular a higher linearity is achieved at both edge regions of the position measuring apparatus 12, 13 according to the invention.

1. Position measuring apparatus to measure the position (s) of an electrically conductive measurement object (28) which is moveable over a measurement section (18), along which coils (14; 14a, 14b; 16) are positioned, wherein an odd number of coils (14; 14a, 14b; 16) is provided; the coils at the odd positions are excitation coils (14; 14a, 14b) which are flowed through by an alternating excitation current (20) respectively which is provided to be in phase opposition, from excitation coil (14; 14a, 14b) to excitation coil (14; 14a, 14b), such that the alternating magnetic fields (22; 15 22a, 22b) generated by the alternating excitation currents (20) induce eddy currents in the electrically conductive measurement object (28) when the measurement object (28) moves past the excitation coils (14; 14a, 14b); the coil (16) at at least one even position between two excitation coils (14; 14a, 14b) is a measurement coil (16) providing a measurement alternating voltage (30, 30′, 30″ . . . ) which is induced by the eddy currents flowing in the measurement object (28) when the measurement object (28) moves past the at least one measurement coil (16); and a determination of the position (s_Mess) of the measurement object (28) is provided on the basis of the at least one measurement alternating voltage (30, 30′, 30″ . . . ).

2. Position measuring apparatus to measure the position (s) of an electrically conductive object (28) which is moveable over a measurement section (18), along which coils (14, 16) are positioned, wherein the coils (14, 16) are excitation coils (14) alternating at the even positions and in chronological order at the odd positions, said excitation coils being flowed through by a alternating excitation current (20) respectively which is provided to be in phase opposition from excitation coil (14) to excitation coil (14) by means of a switching device (92a, 92b) such that the alternating magnetic fields (22) generated by the alternating excitation currents (20) induce eddy currents in the electrically conductive measurement object (28) when the measurement object (28) passes the excitation coils (14); the one coil (16) is alternately connected as a measurement coil (16) at at least one odd position and correspondingly in chronological order at at least one even position between two excitation coils (14) by the switching device (92a, 92b), said measurement coils providing measurement alternating voltages (30, 30′, 30″ . . . ) respectively, which is induced by the eddy currents flowing in the measurement object (28) when the measurement object (28) passes the measurement coils (16); and a determination of the position (s_Mess) of the measurement object (28) is provided on the basis of the measurement alternating voltages (30, 30′, 30″ . . .).

3. Position measuring apparatus according to claim 1, wherein the coils (14, 14a, 14b, 16) are positioned in a row along the measurement section (18) one next to the other; and the measurement object (28) is arranged to toe moveable along the front side of the coils (14, 16).

4. Position measuring apparatus according to claim 3, wherein the coils (14, 14a, 14b, 16) are positioned in a straight line in a row along the measurement section (18) one next to the other; and the measurement object (28) is arranged to be moveable in a straight line along the front side of the coils (14, 14a, 14b, 16).

5. Position measuring apparatus according to claim 1, wherein the coils (14, 14a, 14b, 16) are positioned in a row along the measurement section (18); the coils (14, 16) are implemented to be annular coils (14, 14a, 14b, 16); and the measurement object (28) is arranged to be moveable in the central opening of the annular coils.

6. Position measuring apparatus according to claim 1, wherein the coils (14, 14a, 14b, 16) are positioned along a curved measurement section (18); and the measurement object (28) is arranged to be moveable along the curved measurement section (18).

7. Position measuring apparatus according to claim 6, wherein the coils (14, 14a, 14b, 16) are arranged on a circle periphery along the measurement section (18) one next to the other; and the measurement object (28) is rotationally moveable.

8. Position measuring apparatus according to claim 7, wherein the coils (14, 14a, 14b, 16) are aligned perpendicularly to the rotational axis (80) of the circle and the measurement object (28) is arranged to be rotationally moveably on an inner or outer circle periphery with regard to the coils (14, 14a, 14b, 16).

9. Position measuring apparatus according to claim 7, wherein the coils (14, 14a, 14b, 16) are positioned and aligned in parallel to the rotational axis (80) of the circle on the circumference of the circle; and the measurement object (28) is moved in the axial direction with regard to the coils (14, 14a, 14b, 16) and is arranged to be rotationally moveable.

10. Position measuring apparatus according to claim 1, wherein coil cores (24, 26) are provided and the coil cores (24, 26) are designed to be U-shaped.

11. Position measuring apparatus according to claim 1, wherein coil cores (24, 26) are provided; the coil cores (24, 26) are designed to be E-shaped and the coil windings are arranged on the central E-arm.

12. Position measuring apparatus according to claim 1, wherein an oscillator (60) having direct digital synthesis and a voltage/current converter (62) are provided for providing the alternating excitation current (20).

13. Position measuring apparatus according to claim 1, wherein the excitation coils (14; 14a, 14b) are at least one part of the inductance (L1, L2) of an LC-oscillator (70).

14. Position measuring apparatus according to claim 1, wherein the frequency of the alternating excitation current (20) ranges from 100 kHz to 10 MHz.

15. Position measuring apparatus according to claim 1, wherein a non-ferromagnetic measurement object (28) is provided.

16. Position measuring apparatus according to claim 1, wherein a ferromagnetic measurement object (28) is provided.

17. Method for operating the position measuring apparatus (12, 13) according to claim 1, wherein at least two measurement coils (16) are provided; a certain phase position is allocated to each measurement coil (16); a quadrature signal pair (qₛᵢₙ, q_{cos}) is calculated as the sum of the products of the voltages (U1, U2, . . . Um) which are obtained from the measurement alternating voltages (30, 30′, 30″) provided by the measurement coils (16) by demodulation with the correct preceding sign, and sine functions having a phase position which is allocated to the measurement coils (16) respectively, and, as the sum of the products of the voltages (U1, U2, . . . Um) and cosine functions, likewise having the phase position which is allocated to the measurement coils (16) respectively; and the position (S_Mess) of the measurement object (28) is determined from the phase of the two quadrature signals (qₛᵢₙ, q_{cos}).

18. Method according to claim 17, wherein a background value is detected which occurs without a measurement object (28) present; and the background value is subtracted from the voltages (U1, U2, . . . Um).

19. Method according to claim 17, wherein a normalization to align the ranges (49) is carried out, said ranges (49) lying between positive maxima (44, 44′, 44″) and negative maxima (48, 48′, 48″) of the voltages (U1, U2, . . . Um).

20. Method according to claim 17, wherein a linearization of the connection between the measured and the actual position (S_Mess, s) of the measurement object (28) is carried out.

21. Method according to claim 20, wherein the linearization is carried out by means of a determination of the phase positions allocated to the measurement coils (16).

22. Method according to claim 17, wherein envelope factors (cᵢ^{env}) are provided; the signal courses (40, 40′, 40″ . . . ) having an envelope factor (cᵢ^{env}) respectively are weighted in such a way that the signal courses (40, 40′, 40″ . . . ), which have been gained from the measurement alternating voltages (30, 30′, 30″) of the measurement coils (16), which are positioned at the ends of the measurement section (18), by demodulation with the correct sign, are weighted to be lower than the signal courses (40, 40′, 40″ . . . ), which have been gained from the measurement alternating voltages (30, 30′, 30″) of the measurement coils (16), which are positioned in the center of the measurement section (18), by demodulation with the correct sign.
